(19) United States
(12) Patent Application Publication
(10) Pub. No.: US 2016/0187544 A1
(43) Pub. Date: Jun. 30, 2016

(54) OPTICAL FILM, TRANSPARENT CONDUCTIVE FILM, TOUCH PANEL, SURFACE PROTECTION FILM AND DISPLAY DEVICE

(71) Applicant: FUJIFILM Corporation, Tokyo (JP)

(72) Inventors: Naomi WATANABE, Shizuoka (JP); Naruhiko AONO, Shizuoka (JP); Ryuta TAKEGAMI, Shizuoka (JP)

(73) Assignee: FUJIFILM Corporation, Tokyo (JP)

(21) Appl. No.: 15/065,865

(22) Filed: Mar. 10, 2016

Related U.S. Application Data
(63) Continuation of application No. PCT/JP2014/072708, filed on Aug. 29, 2014.

(30) Foreign Application Priority Data
Sep. 12, 2013 (JP) 2013-189880

(51) Int. Cl. G02B 1/14; G02B 5/30; G02B 1/04

(52) U.S. Cl. CPC G02B 1/14; G02B 1/04; G02B 5/3083

(57) ABSTRACT

An object of the present invention is to provide an optical film in which impact resistance and slipperiness of the film are excellent, and the occurrence of rainbow-like unevenness is suppressed. The present invention relates to an optical film containing a cyclic olefin-based resin and an elastomer, in which a content ratio of the elastomer is 5 mass % to 40 mass % with respect to the total mass of the optical film, and retardation Rth in a thickness direction in terms of a thickness of 40 μm is 6 nm to 90 nm. The present invention further relates to a transparent conductive film, a touch panel, a surface protection film, and a display device.

### CROSS-REFERENCE TO RELATED APPLICATIONS

This application is a Continuation of PCT International Application No. PCT/JP2014/072708, filed on Aug. 29, 2014, which claims priority under 35 U.S.C. Section 119(a) to Japanese Patent Application No. 2013-189880 filed on Sep. 12, 2013. Each of the above applications is hereby expressly incorporated by reference, in its entirety, into the present application.

### BACKGROUND OF THE INVENTION

1. Field of the Invention

The present invention relates to an optical film and a display device. Specifically, the present invention relates to an optical film containing a cyclic olefin-based resin and an elastomer in which retardation (Rth) in a thickness direction is in a specific range. Further, the present invention relates to a display device using the optical film.

2. Description of the Related Art

Recently, the application of a liquid crystal display device, an organic EL display device, a touch panel, and the like has been expanding. In such a device, various resin films have been used in a support, a protection film, and the like. Among them, a film formed of a cyclic olefin-based resin has high heat resistance, low water absorptivity, and excellent dimensional stability, and thus, has been preferably used. In addition, a cyclic olefin copolymer has a low photo-elastic coefficient, and thus, is able to suppress birefringence to be low, and is a material having excellent optical properties.

A demand for a reduction in film thickness or a reduction in weight of the display device or the touch panel has been gradually increasing, and in particular, a reduction in film thickness or a reduction in weight of a resin film has been considered as an important object to be examined. The cyclic olefin-based resin has advantages as described above, but has inferior toughness, and thus, when a reduction in film thickness is performed, a problem occurs in which impact strength is weakened. Thus, a cyclic olefin-based resin film does not have sufficient impact resistance, and thus, handling is difficult, and application is limited.

A method in which rubber such as an elastomer is added or a molecular orientation is obtained by stretching has been examined as an enhancement method of the impact strength of the cyclic olefin-based resin film. For example, in JP2004-156048A, an optical film formed of a cyclic olefin-based resin and an elastomer is disclosed. Here, it is proposed that the optical film is configured of the cyclic olefin-based resin and the elastomer, and thus, toughness or transparency increases.

In addition, in WO2009/041310A, an optical film using a cyclic olefin-based resin which is formed through a stretching step is disclosed. Here, it is proposed that the stretching step is provided, and thus, brittleness is improved.

### SUMMARY OF THE INVENTION

However, as in JP2004-156048A and WO2009/041310A, even in the optical film using the cyclic olefin-based resin in which toughness or the like is enhanced, the impact resistance is not sufficient, and thus, further enhancement has been required.

In addition, in the optical film using the cyclic olefin-based resin of the related art, there is a problem in which rainbow-like unevenness may occur at the time of changing a view angle. Such occurrence of the rainbow-like unevenness negatively affects display performance at the time of using the optical film in a display device or the like, and thus, becomes a problem.

Further, according to the examination of the present inventors, it has been found that in the optical film using the cyclic olefin-based resin of the related art, slipperiness between films may deteriorate. In a case where the slipperiness between the films deteriorates, a problem easily occurs at the time of manufacturing the film. In particular, in a case where the slipperiness between the films deteriorates at the time of winding the film, the film is broken or is damaged at the time of being wound, and thus, the deterioration in the slipperiness between the films becomes a problem.

Therefore, in order to solve such problems of the related art, the present inventors have progressed examinations for providing an optical film in which impact resistance and slipperiness of the film are excellent, and the occurrence of rainbow-like unevenness is suppressed.

As a result of intensive examinations for solving the problems described above, the present inventors have found that in an optical film containing a cyclic olefin-based resin and an elastomer, a content ratio of the elastomer is set to be in a predetermined range, and retardation (Rth) of the optical film in a thickness direction is set to 6 nm to 90 nm, and thus, it is possible to obtain an optical film in which impact resistance and slipperiness of the film are excellent, and the occurrence of rainbow-like unevenness is suppressed.

Specifically, the present invention has the following configurations.

[1] An optical film including a cyclic olefin-based resin; and an elastomer, in which a content ratio of the elastomer is 5 mass % to 40 mass % with respect to the total mass of the optical film, and retardation Rth in a thickness direction in terms of a thickness of 40 μm is 6 nm to 90 nm.

[2] The optical film according to [1], in which a difference in refractive indices of the cyclic olefin-based resin and the elastomer is less than or equal to 0.02.

[3] The optical film according to [1] or [2], in which a thickness of the optical film is 10 μm to 100 μm.

[4] The optical film according to any one of [1] to [3], in which the thickness of the optical film is 10 μm to 50 μm.

[5] The optical film according to any one of [1] to [4], in which the cyclic olefin-based resin is an addition copolymer including an ethylene unit and a norbornene unit.

[6] The optical film according to any one of [1] to [5], in which the elastomer contains an aromatic vinyl-based compound as a copolymerization component.

[7] The optical film according to any one of [1] to [6], in which the elastomer is a styrene-ethylene-butylene-styrene block copolymer, a styrene-ethylene-propylene-styrene block copolymer, or a styrene-isobutylene-styrene block copolymer.

[8] The optical film according to any one of [1] to [7], in which the optical film is stretched in at least a monoaxial direction.

[9] The optical film according to any one of [1] to [8], in which the optical film is biaxially stretched.

[10]A transparent conductive film including the optical film according to any one of [1] to [9]; and a transparent conductive layer.

[11]A touch panel including the transparent conductive film according to [10].

[12]A surface protection film using the optical film according to any one of [1] to [9].

[13]A display device using the optical film according to any one of [1] to [9].

According to the present invention, it is possible to obtain an optical film in which impact resistance and slipperiness of the film are excellent, and the occurrence of rainbow-like unevenness is suppressed. The optical film of the present invention has properties as described above, and thus, is preferably used as a film for a display device or a touch panel.

In addition, the optical film of the present invention has excellent slipperiness, and thus, handling properties in a manufacturing step are excellent, and production suitability is high.

### DESCRIPTION OF THE PREFERRED EMBODIMENTS

Hereinafter, the present invention will be described in detail. The following description of configuration requirements are based on representative embodiments or specific examples, but the present invention is not limited to the embodiments. Furthermore, herein, “to” indicates a range including the numerical values before and after “to” as the lower limit value and the upper limit value.

(Optical Film)

An optical film of the present invention contains a cyclic olefin-based resin and an elastomer. A content ratio of the elastomer is 5 mass % to 40 mass % with respect to the total mass of the optical film. In addition, retardation (Rth) of the optical film in a thickness direction in terms of a thickness of 40 μm is 6 nm to 90 nm.

The retardation (Rth) of the optical film in the thickness direction in terms of a thickness of 40 min may be 6 nm to 90 nm, is preferably 8 nm to 85 nm, and is more preferably 10 nm to 80 nm. In the present invention, the retardation (Rth) in the thickness direction which is converted per unit thickness (40 μm) is suppressed to be low, and in a case where the optical film is used in a display device or the like, the occurrence of rainbow-like unevenness is able to be suppressed.

Retardation (Re) of the optical film in an in-plane direction is preferably 0 nm to 20 nm, and is more preferably 0 nm to 10 nm.

The retardation (Re) of the optical film in the in-plane direction is defined by the following Expression (1), and the retardation (Rth) of the optical film in the thickness direction is defined by the following Expression (2).

Re=(nx−ny)×d (1)

Rth={(nx+ny)/2−nz}×d (2)

In Expressions (1) and (2), nx represents a refractive index in a slow axis direction in the optical film plane, ny represents a refractive index in a fast axis direction in the optical film plane, nz represents a refractive index of the optical film in the thickness direction, and d represents the thickness of the optical film.

The retardation (Re) of the optical film in the in-plane direction and the retardation (Rth) of the optical film in the thickness direction are able to be measured at a light ray wavelength of 550 nm by using KOBRA 21ADH or WR manufactured by Oji Scientific Instruments. Re is measured in a state where an incidence light ray is perpendicular to the film surface.

Rth is obtained by measuring a phase difference value at each angle by gradually changing an angle between the incidence light ray and the film surface, by obtaining nx, ny, and nz, which are three-dimensional refractive indices, by performing curve fitting in a known expression of a refractive index ellipsoid, and by substituting nx, ny, and nz into Rth={(nx+ny)/2−nz}×d. In the present invention, Rth of the unit thickness (40 μm) is calculated by substituting 40 to d.

Furthermore, in the measurement, the average refractive index of the film is necessary, and is able to be separately measured by using an Abbe's refractometer (a product name of “Abbe's refractometer 2-T”, manufactured by Atago Co., Ltd.).

A difference in the refractive indices between the cyclic olefin-based resin and the elastomer contained in the optical film of the present invention is preferably less than or equal to 0.02, is more preferably less than or equal to 0.01, and even more preferably less than or equal to 0.005. In the present invention, by setting the difference in the refractive indices between the cyclic olefin-based resin and the elastomer to be in the range described above, it is possible to increase transparency of the optical film, and it is possible to suppress an increase in haze of the optical film. Furthermore, here, the difference in the refractive indices between the cyclic olefin-based resin and the elastomer being less than or equal to 0.02 indicates that the absolute value of the difference in the refractive indices is less than or equal to 0.02.

The film thickness of the optical film of the present invention is 10 μm to 100 Jim, is preferably 10 μm to 60 μm, and is more preferably 10 pin to 50 μm. Thus, in the optical film of the present invention, a reduction in film thickness is able to be performed. Here, the film thickness of the optical film indicates the average film thickness of the film.

It is preferable that the optical film of the present invention is stretched in at least a monoaxial direction of a vertical direction (MD) or a horizontal direction (TD), and it is more preferable that the optical film is biaxially stretched in the vertical direction (MD) and the horizontal direction (TD). In a case where the optical film is biaxially stretched in the vertical direction or the horizontal direction, the stretching may be performed in the sequence of Vertical Direction→Horizontal Direction, Horizontal Direction→Vertical Direction, or may be simultaneously performed in two directions. Further, for example the stretching may be performed in multiple stages such as Vertical Direction→Vertical Direction→Horizontal Direction, Vertical Direction→Horizontal Direction→Vertical Direction, and Vertical Direction→Horizontal Direction→Horizontal Direction.

In general, in a case where the film is formed by stretching the cyclic olefin-based resin, it is possible to make the film thickness thin, but the retardation in the in-plane direction or the thickness direction tends to increase. However, in the present invention, in the optical film containing the cyclic olefin-based resin and the elastomer, the content ratio of the elastomer is set to be in a predetermined range, and the manufacturing conditions are set to conditions described below, and thus, it is possible to suppress the retardation in the thickness direction to be low while performing a reduction in film thickness.

(Cyclic Olefin-Based Resin)

The cyclic olefin-based resin indicates a polymer resin having a cyclic olefin structure. Examples of the polymer resin having a cyclic olefin structure include (1) a norbornene-based polymer, (2) a polymer of a cyclic olefin having a monocyclic ring, (3) a polymer of cyclic conjugated diene, (4) a vinyl alicyclic hydrocarbon polymer, a hydride of (1) to (4), and the like.

It is preferable that the cyclic olefin-based resin used in the present invention is an addition copolymer including an ethylene unit and a norbornene unit.

<Norbornene Unit>

Preferred examples of a norbornene resin (norbornene unit) which is the raw material of the cyclic olefin-based resin of the present invention are able to include a saturated norbornene resin-A and a saturated norbornene resin-B described below. Both of the saturated norbornene resins are able to form a film by a solution film formation method and a melting film formation method described below, but it is more preferable that the saturated norbornene resin-A forms a film by the melting film formation method, and it is more preferable that the saturated norbornene resin-B forms a film by the solution film formation method.

(Saturated Norbornene Resin-A)

Examples of the saturated norbornene resin-A are able to include (1) a resin obtained by adding, as necessary, a maleic acid to a ring-opening (co)polymer of a norbornene-based monomer, by performing polymer modification such as cyclopentadiene addition, and then by further performing hydrogenation, (2) a resin obtained by performing addition type polymerization with respect to a norbornene-based monomer, (3) a resin obtained by performing addition type copolymerization between a norbornene-based monomer and an olefin-based monomer such as ethylene or α-olefin, and the like. A polymerization method and a hydrogenation method are able to be performed by an ordinary method.

Examples of the norbornene-based monomer include a polar group substituent such as norbornene, and alkyl and/or substituted alkylidene thereof (for example, 5-methyl-2-norbornene, 5-dimethyl-2-norbornene, 5-ethyl-2-norbornene, 5-butyl-2-norbornene, 5-ethylidene-2-norbornene, and the like), and halogen thereof; dicyclopentadiene, 2,3-dihydro dicyclopentadiene, and the like; a polar group substituent (for example, 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, 6-methoxycarbonyl-1,4:5,8-dimethano-1,4,4a,5,6,7,8,8a-octahydronaphthalene, and the like) such as dimethanooctahydronaphthalene, alkyl and/or substituted alkylidene thereof, and halogen; an adduct between cyclopentadiene and tetrahydroindene or the like; a trimer to a tetramer of cyclopentadiene (for example, 4,9:5,8-dimethano-3a,4,4a,5,8,8a,9,9a-octahydro-1H-benzoindene and 4,11:5,10:6,9-trimethano-3a,4,4a,5,5a,6,9,9a, 10,10a,11,11a-dodecahydro-1H-cyclopentaanthracene), and the like. The norbornene-based monomer may be independently used, or two or more types thereof may be used in combination.

(Saturated Norbornene Resin-B)

Examples of the saturated norbornene resin-B are able to include resins denoted by the following General Formulas (1) to (4). Among them, the resin denoted by the following General Formula (1) is particularly preferable.

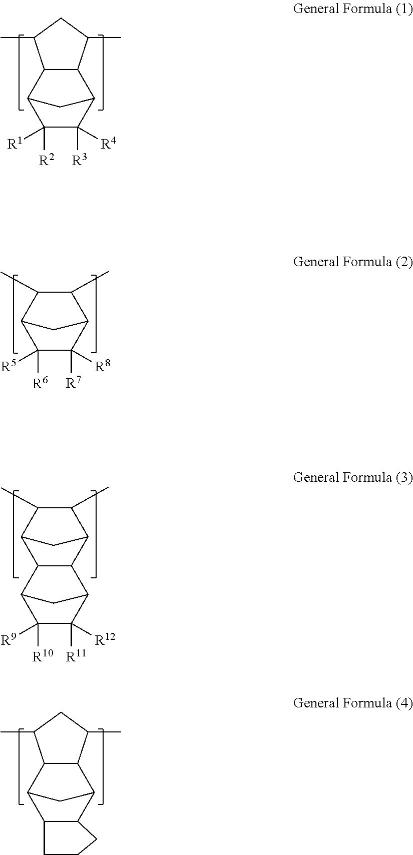

In General Formulas (1) to (4), R¹ to R¹² each independently represents a hydrogen atom or a monovalent substituent group (preferably an organic group), and it is preferable that at least one of them is a polar group. In general, the mass average molecular weight of the saturated norbornene resin is preferably 5,000 to 1,000,000, and is more preferably 8,000 to 200,000.

Substituent groups disclosed in paragraph “0036” of JP5009512B are able to be exemplified as the substituent group. In addition, polar groups disclosed in paragraph “0037” of JP5009512B are able to be exemplified as the polar group described above.

Examples of the saturated norbornene resin which is able to be used in the present invention are able to include resins and the like disclosed in JP1985-168708A (JP-S60-168708A), JP1987-252406A (JP-S62-252406A), JP1987-252407A (JP-S62-252407A), JP1990-133413A (JP-H02-133413A), JP1988-145324A (JP-S63-145324A), JP1988-264626A (JP-S63-264626A), JP1989-240517A (JP-H01-240517A), JP1982-8815B (JP-S57-8815B), and the like.

Among the resins, a hydrogenated polymer which is obtained by performing hydrogenation with respect to a ring-opening polymer of a norbornene-based monomer is particularly preferable.

In the present invention, at least one type of tetracyclododecene derivative denoted by the following General Formula (5) is able to be independently used as the saturated norbornene resin, or a hydrogenated polymer obtained by performing hydrogenation with respect to a polymer which is obtained by metathesis polymerization between a tetracyclododecene derivative and an unsaturated cyclic compound which is able to be copolymerized with the tetracyclododecene derivative is able to be used as the saturated norbornene resin.

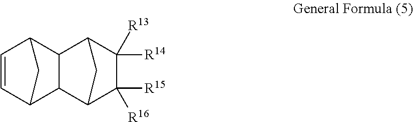

In General Formula (5), R¹³ to R¹⁶ each independently represents a hydrogen atom or a monovalent substituent group (preferably an organic group), and it is preferable that at least one of them is a polar group. Here, the preferred range of specific examples of the substituent group and the polar group is identical to that described in General Formulas (1) to (4).

In the tetracyclododecene derivative denoted by General Formula (5) described above, at least one of R¹³ to R¹⁶ is a polar group, and thus, it is possible to obtain an optical film having excellent adhesiveness with respect to other materials, heat resistance, and the like. Further, it is preferable that the polar group is a group denoted by —(CH₂)ₙCOOR (here, R represents a hydrocarbon group having 1 to 20 carbon atoms, and n represents an integer of 0 to 10) since a hydrogenated polymer which is finally obtained (a substrate of a polarizing film) has a high glass-transition temperature. In particular, it is preferable that one polar substituent group denoted by —(CH₂)ₙCOOR is contained in one molecule of the tetracyclododecene derivative of General Formula (5) from a viewpoint of decreasing water absorptivity. In the polar substituent group described above, it is preferable that the number of carbon atoms of the hydrocarbon group denoted by R becomes larger from a viewpoint of decreasing hygroscopicity of a hydrogenated polymer to be obtained, and the hydrocarbon group is preferably a chain-like alkyl group having 1 to 4 carbon atoms or a (poly)cyclic alkyl group having carbon atoms of greater than or equal to 5, and is particularly preferably a methyl group, an ethyl group, and a cyclohexyl group, from a viewpoint of a balance with respect to the glass-transition temperature of the hydrogenated polymer to be obtained.

Further, the tetracyclododecene derivative of General Formula (5) in which a hydrocarbon group having 1 to 10 carbon atoms is bonded to a carbon atom to which a group denoted by —(CH₂)ₙCOOR is bonded as a substituent group is preferable since hygroscopicity of a hydrogenated polymer to be obtained is low. In particular, the tetracyclododecene derivative of General Formula (5) in which the substituent group is a methyl group or an ethyl group is preferable from a viewpoint of easy synthesis. Specifically, 8-methyl-8-methoxycarbonyl tetracyclo[4,4,0,1^{2.5},1^{7.10}]dodeca-3-en is preferable. A mixture of the tetracyclododecene derivative and the unsaturated cyclic compound which is able to be copolymerized with the tetracyclododecene derivative, for example, is able to be subjected to metathesis polymerization and hydrogenation by a method disclosed in line 12 of the upper right column on page 4 to line 6 of the lower right column on page 6 of JP1992-77520A (JP-H04-77520A).

In the norbornene-based resin, intrinsic viscosity (ηᵢₙₕ) measured at 30° C. in chloroform is preferably 0.1 dl/g to 1.5 dl/g, and is more preferably 0.4 dl/g to 1.2 dl/g. In addition, in a hydrogenation rate of the hydrogenated polymer, a value measured at 60 MHz and ¹H-NMR is preferably greater than or equal to 50%, is more preferably greater than or equal to 90%, and is even more preferably greater than or equal to 98%. As the hydrogenation rate becomes higher, stability of a saturated norbornene film to be obtained with respect to heat or light becomes excellent. The content of gel contained in the hydrogenated polymer is preferably less than or equal to 5 mass %, and is more preferably less than or equal to 1 mass %.

(Other Ring-Opening Polymerizable Cycloolefins)

In the present invention, other ring-opening polymerizable cycloolefins are able to be used together within a range not impairing the object of the present invention. A reactive compound having one double bond, such as cyclopentene, cyclooctene, and 5,6-dihydrodicyclopentadiene is exemplified as a specific example of such cycloolefins. The content of the ring-opening polymerizable cycloolefins is preferably 0 mol % to 50 mol %, is more preferably 0.1 mol % to 30 mol %, and is particularly preferably 0.3 mol % to 10 mol %, with respect to the norbornene-based monomer.

<Ethylene Unit>

The ethylene unit used in the present invention is a repeating unit denoted by —CH₂CH₂—. The ethylene unit is subjected to vinyl polymerization along with the norbornene unit described above, and thus, a cyclic olefin copolymer is obtained.

In the present invention, a copolymerization ratio of the norbornene unit to the ethylene unit is preferably 80:20 to 60:40, is more preferably 80:20 to 65:35, and is even more preferably 80:20 to 70:30.

Furthermore, the cyclic olefin copolymer may contain a small amount of a repeating unit formed of other copolymerizable vinyl monomers in addition to the ethylene unit and the norbornene unit within a range not impairing the object of the present invention. Specifically, examples of the other vinyl monomer are able to include α-olefin having 3 to 18 carbon atoms, such as propylene, 1-butene, 1-hexene, 4-methyl-1-pentene, 1-octene, 1-decene, 1-dodecene, 1-tetradecene, 1-hexadecene, and 1-octadecene, cycloolefin such as cyclobutene, cyclopentene, cyclohexene, 3-methylcyclohexene, and cyclooctene, and the like. Such a vinyl monomer may be independently used or two or more types thereof may be used in combination, and the repeating unit is preferably less than or equal to 10 mol %, and is more preferably less than or equal to 5 mol %, with respect to the total vinyl monomer.

The glass-transition temperature (Tg) of the cyclic olefin-based resin is preferably 120° C. to 210° C., is more preferably 130° C. to 200° C., and is even more preferably 130° C. to 190° C. Thus, by setting the glass-transition temperature (Tg) of the cyclic olefin-based resin to be in the range described above, it is possible to form a film from a cyclic olefin-based resin, and it is possible to suppress the occurrence wrinkles in the film in a case of using the film in various display devices or the like.

(Elastomer)

Examples of the elastomer which is able to be used in the present invention include a styrene-based elastomer, an olefin-based elastomer, a urethane-based elastomer, a polyester-based elastomer, a polyamide-based elastomer, an acrylic elastomer, a silicone-based elastomer, and the like. One type or two or more types of elastomers are used in the optical film of the present invention.

In the present invention, among the elastomers described above, it is preferable that the aromatic vinyl-based compound is contained as a copolymerization component, and it is particularly preferable that the styrene-based elastomer is contained as a copolymerization component.

<Styrene-Based Elastomer>

Examples of the styrene-based elastomer include a copolymer of conjugated diene and/or a hydrogenated product thereof, such as styrene, butadiene, or isoprene. The styrene-based elastomer is a block copolymer in which styrene is set to a hard segment and conjugated diene is set to a soft segment, and does not require a vulcanizing step, and thus, is preferably used. In addition, the styrene-based elastomer which is subjected to hydrogenation has high heat stability, and thus, is more preferably used.

Examples of the styrene-based elastomer are able to include a styrene-butadiene-styrene block polymer, a styrene-isoprene-styrene block polymer, a styrene-ethylene-butylene-styrene block polymer, a styrene-ethylene-propylene-styrene block polymer, a styrene-isobutylene-styrene block copolymer, and the like. Among them, the styrene-ethylene-butylene-styrene block copolymer, the styrene-ethylene-propylene-styrene block copolymer, or the styrene-isobutylene-styrene block copolymer is preferable.

In addition to the styrene, styrene derivatives such as α-methyl styrene, 3-methyl styrene, 4-propyl styrene, and 4-cyclohexyl styrene are able to be used as a component configuring the styrene-based elastomer. Specifically, Tufprene, Solprene T, Asaprene T, and Tuftec (which are manufactured by Asahi Kasei Chemicals Corporation), Elastomer AR (manufactured by ARONKASEI CO., LTD.), Kraton D, Kraton G, and Cariflex (which are manufactured by Kraton Performance Polymers Inc.), JSR-TR, TSR-SIS, and Dynaron (which are manufactured by JSR Corporation), Denka STR (manufactured by Denka Company Limited), Quintac (manufactured by Zeon Corporation), TPE-SB Series (manufactured by Sumitomo Chemical Company, Limited), Rabalon (manufactured by Mitsubishi Chemical Corporation), Septon and Hybrar (which are manufactured by KURARAY CO., LTD), Leostomer and Actymer (which are manufactured by Riken technos Corporation), and the like.

A difference between the refractive index of the styrene-based elastomer used in the present invention and the refractive index of the cyclic olefin-based resin is preferably less than or equal to 0.02, is more preferably less than or equal to 0.01, and is even more preferably less than or equal to 0.005. In a case where the styrene-based elastomer which is subjected to hydrogenation is used, and the amount of styrene component in the elastomer is 40 weight % to 70 weight %, it is possible to set the difference between the refractive index of the styrene-based elastomer used in the present invention and the refractive index of the cyclic olefin-based resin to be in the in the range described above.

The content ratio of the elastomer may be 5 mass % to 40 mass %, and is preferably 10 mass % to 30 mass %, with respect to the total mass of the optical film. By setting the content ratio of the elastomer to be in the range described above, it is possible to increase toughness or impact resistance of the optical film.

A ratio of mass % of the cyclic olefin-based resin/the styrene-based elastomer is 99/1 to 50/50, is preferably 95/5 to 50/50, is more preferably 93/7 to 60/40, and is particularly preferably 90/10 to 65/35 (the total mass % of the cyclic olefin-based resin and the styrene-based elastomer is 100 mass %). By setting the addition ratio of the styrene-based elastomer to be in the range described above, it is possible to increase mechanical strength.

The structure of the styrene-based elastomer is not particularly limited, but the styrene-based elastomer may be a chain-like styrene-based elastomer, a branched styrene-based elastomer, or a cross-linked styrene-based elastomer, and the straight chain-like styrene-based elastomer is preferable.

In addition, in the molecular weight of the styrene-based elastomer, the number average molecular weight obtained by a GPC method is 5000 to 300000, is preferably 10000 to 150000, and is more preferably 20000 to 100000. By setting the molecular weight of the styrene-based elastomer to be in the range described above, it is possible to increase mechanical strength or molding properties.

Examples of the elastomer which is able to be used in the present invention are able to include the following elastomers in addition to the styrene-based elastomer. Furthermore, it is preferable that the following elastomers are used together with the styrene-based elastomer.

<Olefin-Based Elastomer>

The olefin-based elastomer is a copolymer of α-olefin having 2 to 20 carbon atoms such as ethylene, propylene, 1-butene, 1-hexene, and 4-methyl-pentene, and examples of the olefin-based elastomer include an ethylene-propylene copolymer (EPR), an ethylene-propylene-diene copolymer (EPDM), non-conjugated diene having 2 to 20 carbon atoms such as dicyclopentadiene, 1,4-hexadiene, cyclooctadiene, methylene norbornene, ethylidene norbornene, butadiene, and isoprene, an α-olefin copolymer, and the like. In addition, examples of the olefin-based elastomer include carboxy-modified NBR in which a methacrylic acid is copolymerized with a butadiene-acrylonitrile copolymer. Specifically, examples of the olefin-based elastomer include ethylene and α-olefin copolymer rubber, ethylene and α-olefin and non-conjugated diene copolymer rubber, propylene and α-olefin copolymer rubber, butene and α-olefin copolymer rubber, and the like.

<Urethane-Based Elastomer>

The urethane-based elastomer is formed of structure unit including a hard segment which is formed of low molecular ethylene glycol and diisocyanate and a soft segment which is formed of high molecular (long chain) diol and diisocyanate, in which examples of the high molecular (long chain) diol include polypropylene glycol, polytetramethylene oxide, poly(1,4-butylene adipate), poly(ethylene-1,4-butylene adipate), polycaprolactone, poly(1,6-hexylene carbonate), poly(1,6-hexylene and neopentylene adipate), and the like. It is preferable that the number average molecular weight of the high molecular (long chain) diol is 500 to 10,000. In addition to the ethylene glycol, short chain diol such as propylene glycol, 1,4-butanediol, and bisphenol A is able to be used, and it is preferable that the number average molecular weight of the short chain diol is 48 to 500.

<Polyester-Based Elastomer>

The polyester-based elastomer is obtained by performing polycondensation between a dicarboxylic acid or a derivative thereof and a diol compound or a derivative thereof. Specific examples of the dicarboxylic acid include an aromatic dicarboxylic acid such as a terephthalic acid, an isophthalic acid, and a naphthalene dicarboxylic acid and an aliphatic dicarboxylic acid having 2 to 20 carbon atoms, in which a hydrogen atom of an aromatic nucleus of the aromatic dicarboxylic acid is substituted with a methyl group, an ethyl group, a phenyl group, and the like, such as an aromatic dicarboxylic acid, an adipic acid, a sebacic acid, and a dodecane dicarboxylic acid, an alicyclic dicarboxylic acid such as a cyclohexane dicarboxylic acid, and the like. Two or more types of compounds described above are able to be used. Specific examples of the diol compound include aliphatic diol and alicyclic diol such as ethylene glycol, 1,3-propanediol, 1,4-butanediol, 1,6-hexanediol, 1,10-decanediol, and 1,4-cyclohexanediol, aromatic cyclic diol such as bisphenol A, bis-(4-hydroxy phenyl)-methane, bis-(4-hydroxy-3-methyl phenyl)-propane, and resorcin, and the like. Two or more types of compounds described above are able to be used.

In addition, a multiblock copolymer is able to be used in which an aromatic polyester (for example, polybutylene terephthalate) portion is set to a hard segment component and an aliphatic polyester (for example, polytetramethylene glycol) portion is set to a soft segment component. There are multiblock copolymers having various grades according to a difference in the type, the ratio, and the molecular weight of the hard segment and the soft segment.

<Polyamide-Based Elastomer>

The polyamide-based elastomer is roughly classified into two types of polyamide-based elastomers including a polyether block amide type elastomer in which polyamide is used in a hard phase and polyether or polyester is used in a soft phase, and a polyether ester block amide type elastomer, in which polyamide-6, 11, 12, and the like are used as the polyamide, and polyoxy ethylene, polyoxy propylene, polytetramethylene glycol, and the like are used as the polyether.

The acrylic elastomer includes acrylic acid ester as a main component, ethyl acrylate, butyl acrylate, methoxy ethyl acrylate, ethoxy ethyl acrylate, and the like are used as the acrylic elastomer, and glycidyl methacrylate, allyl glycidyl ether, and the like are used as a cross-linking monomer. Further, it is possible to perform copolymerization with respect to acrylonitrile or ethylene. Specifically, examples of the copolymer of the acrylonitrile or the ethylene include an acrylonitrile-butyl acrylate copolymer, an acrylonitrile-butyl acrylate-ethyl acrylate copolymer, an acrylonitrile-butyl acrylate-glycidyl methacrylate copolymer, and the like.

<Silicone-Based Elastomer>

The silicone-based elastomer includes organopolysiloxane as a main component, and is classified into a polydimethyl siloxane-based elastomer, a polymethyl phenyl siloxane-based elastomer, and a polydiphenyl siloxane-based elastomer. There is a silicone-based elastomer of which a part is modified with a vinyl group, an alkoxy group, and the like.

<Rubber-Modified Epoxy Compound>

In addition, a rubber-modified epoxy compound is able to be used in addition to the elastomers described above. Specifically, examples of the rubber-modified epoxy compound include epoxidized polybutadiene (PB3600 and PB4700, manufactured by Daicel Corporation), an epoxidized butadiene-styrene copolymer (epoxidized butadiene-styrene, Epofriend AT014 and the like, manufactured by Daicel Corporation), an epoxy compound of polydimethyl siloxane X22-163B and KF100T (manufactured by Shin-Etsu Chemical Co., Ltd.), and the like. In addition, a rubber-modified epoxy compound which is obtained by modifying a part or all of epoxy groups of a bisphenol F-type epoxy resin, a bisphenol A-type epoxy resin, a salicyl aldehyde-type epoxy resin, a phenol novolac-type epoxy resin, and a cresol novolac-type epoxy resin described above with both-terminal carboxylic acid-modified butadiene-acrylonitrile rubber, terminal amino-modified silicone rubber, and the like is able to be used.

(Other Additives)

Other additives are able to be added to the optical film of the present invention within a range not impairing the object of the present invention. Examples of the additive are able to include an antioxidant, an ultraviolet absorber, a lubricant, and an antistatic agent. In particular, in a case where the optical film is disposed on the surface of various devices, it is preferable that the optical film contains the ultraviolet absorber. A benzophenone-based ultraviolet absorber, a benzotriazole-based ultraviolet absorber, an acrylonitrile-based ultraviolet absorber, and the like are able to be used as the ultraviolet absorber.

(Manufacturing Method of Optical Film)

The optical film is able to be formed by either a solution film formation method or a melting film formation method. The film formation method will be described below in detail.

(Melting Film Formation)

(1) Melting

Before the cyclic olefin-based resin is subjected to melting film formation, it is preferable that the cyclic olefin-based resin is mixed and pelletized. By pelletizing the cyclic olefin-based resin, it is possible to suppress surging in a hopper of a melting extruder, and it is possible to stably supply the cyclic olefin-based resin. In a preferred size of a pellet, a sectional area is 1 mm² to 300 mm², and a length is 1 mm to 30 mm.

The pellet of the cyclic olefin-based resin and the elastomer are put into the melting extruder, and are subjected to dehydration at 100° C. to 200° C. for 1 minute to 10 hours, and then are subjected to kneading extrusion. The kneading is able to be performed by using a monoaxial or a biaxial extruder.

In general, a uniaxial extruder which has comparatively low equipment cost is mainly used, a screw type extruder such as Full Flight, Maddox, and Dulmage is included as the type of extruder, and a full flight type extruder is preferable. In addition, by changing a screw segment, it is possible to use a biaxial extruder which is able to perform extrusion while performing devolatilization with respect to unnecessary volatile components by disposing a vent port in the middle of the extruder. The biaxial extruder is roughly classified into an extruder rotating in the same direction and an extruder rotating in different directions, and both extruders are able to be used, but the extruder rotating in the same direction in which an accumulation portion is rarely generated and self-cleaning performance is high is preferable.

The biaxial extruder has high kneading properties and high resin supply performance, and thus, is able to perform extrusion at a low temperature and is suitable for the film formation of the present invention.

(2) Filtration

In order to filter foreign substances in the resin or avoid damage of a gear pump due to the foreign substances, it is preferable that so-called breaker plate type filtration is performed in which a filter material is provided in an extruder outlet. In addition, in order to perform foreign substance filtration with higher accuracy, it is preferable that a filtration device provided with a so-called leaf type disk filter is disposed after passing through the gear pump. The filtration is able to be performed by disposing one filtration portion, and multi-stage filtration may be performed by disposing a plurality of filtration portions. It is preferable that filtration accuracy of a filter material is high, and the filtration accuracy is preferably 15 μm to 3 μm, and is more preferably 10 μm to 3 μm, from a viewpoint of an increase in a filtration pressure due to pressure resistance of the filter material or clogging of the filter material. In particular, in a case where a leaf type disk filter device is used in which the foreign substance filtration is performed at the final stage, it is preferable that a filter material having high filtration accuracy is used from a viewpoint of quality, and the number of filter materials is able to be adjusted in order to ensure pressure resistance and suitability of filter life. In the type of filter material, it is preferable that an iron steel material is used from a viewpoint of being used under high temperature and high pressure, and among the iron steel materials, stainless steel, steel, and the like are preferably used, and the stainless steel is particularly preferably used from a viewpoint of corrosion. In the configuration of the filter material, for example, a sintered filter material which is formed by sintering a metal long fiber or a metal powder is able to be used in addition to a woven wire material, and the sintered filter material is preferable from a viewpoint of filtration accuracy and filter life.

(3) Gear Pump

In order to improve thickness accuracy, it is important to reduce a variation in a discharge amount, and it is preferable that a gear pump is disposed between the extruder and a die and a constant amount of resin is supplied from the gear pump. The gear pump contains a pair of gears formed of a driving gear and a driven gear in a state where the pair of gears are engaged to each other, and in the gear pump, both gears are engagedly rotated by driving the driving gear, the resin in a melted state is sucked into a cavity from a suction port which is formed in the housing, and a constant amount of resin is discharged from a discharge port which is also formed in the housing. Even in a case where the pressure of the resin on a tip portion of the extruder slightly varies, the variation is absorbed by using the gear pump, and thus, a variation in the pressure of the resin on the downstream of the film formation device becomes excessively small, and a thickness variation is reduced. By using the gear pump, it is possible to set a variation width in the pressure of the resin in a die portion to be less than or equal to ±1%.

In order to improve quantitative supply performance of the gear pump, it is possible to also use a method in which the pressure before the gear pump is controlled to be constant by changing the number of rotations of a screw. In addition, a high accuracy gear pump using three or more gears in which a variation in the gears of the gear pump is solved is also effective.

(4) Die

The resin is melted by the extruder configured as described above, and as necessary, the melted resin is continuously fed to a die through the filtration machine and the gear pump.

In general, any type of die of a T die, a fish tail die, and a coat hanger die is able to be used as the die insofar as in the amount of melted resin accumulated the die is small. In addition, in order to improve evenness in the temperature of the resin immediately before the die, a static mixer may be incorporated. In general, clearance of a die outlet portion may be 1.0 time to 5.0 times the film thickness, is preferably 1.2 times to 3 times the film thickness, and is more preferably 1.3 times to 2 times the film thickness. In a case where lip clearance is greater than or equal to 1.0 time the film thickness, it is preferable since a sheet having excellent planarity is easily obtained by film formation. In addition, in a case where the lip clearance is less than or equal to 5.0 times the film thickness, it is preferable since thickness accuracy of the sheet is easily improved. The die is a critically important facility determining thickness accuracy of the film, and a die is preferable in which thickness adjustment is able to be precisely controlled. In addition, a design is important in which temperature unevenness or flow rate unevenness in a width direction of the die is minimized.

(5) Casting

The melted resin which is extruded into the shape of a sheet by the die in the method described above is cooled and solidified on a casting drum, and thus, an unstretched film is obtained. At this time, it is preferable that adhesiveness between the casting drum and the sheet which is melted and extruded is improved by using a method such as a static electricity applying method, an air knife method, an air chamber method, a vacuum nozzle method, and a touch roll method. Such an adhesion improvement method may be performed with respect to the entire surface of the sheet which is melted and extruded, or may be performed with respect to a part of the sheet. In particular, a method referred to as edge peening is mainly used in which only both end portions of the film are subjected to adhesion, but the present invention is not limited thereto.

It is more preferable that the casting drum is slowly cooled by using a plurality of cooling rolls, and in particular, the slow cooling is generally and comparatively frequently performed by using three cooling rolls, but the present invention is not limited thereto. The diameter of the roll is preferably 50 mm to 5000 mm, and a gap between the surfaces of a plurality of rolls is preferably 0.3 mm to 300 mm.

The temperature of the casting drum is preferably Tg of the cyclic olefin-based resin−70° C. to Tg+20° C., is more preferably Tg−50° C. to Tg+10° C., and is even more preferably Tg−30° C. to Tg+5° C.

In addition, in a case where a so-called touch roll method is used, the surface of the touch roll may be formed of a resin such as rubber and Teflon (Registered Trademark), or the touch roll may be a metal roll. Further, it is possible to use a roll referred to as a flexible roll in which the thickness of the metal roll becomes thin, and thus, the surface of the roll is slightly indented due to a pressure at the time of being touched, and a crimping area becomes wide.

The temperature of the touch roll is preferably Tg−70° C. to Tg+20° C., is more preferably Tg−50° C. to Tg+10° C., and is even more preferably Tg−30° C. to Tg+5° C.

(6) Stretching

It is preferable that a cast film (an unstretched raw material) extruded onto the casting drum as described above is stretched in at least a monoaxial direction of the vertical direction (MD) or the horizontal direction (TD), and it is more preferable that the cast film is biaxially stretched in the vertical direction (MD) and the horizontal direction (TD). In a case where the cast film is biaxially stretched in the vertical direction and the horizontal direction, the stretching may be performed in the sequence of Vertical Direction→Horizontal Direction, Horizontal Direction→Vertical Direction, or may be simultaneously performed in two directions. Further, it is preferable that the stretching is performed in multi-stage such as Vertical Direction→Vertical Direction→Horizontal Direction, and Vertical Direction→Horizontal Direction→Vertical Direction, and Vertical Direction→Horizontal Direction→Horizontal Direction.

The vertical stretching is able to be attained by disposing two or more pairs of nip rolls, in general, and by setting the rotation speed of the nip roll on the outlet side to be faster than that of the nip roll on the inlet side while allowing a raw material which is heated to pass through a space between the rolls. At this time, as described above, it is preferable that a temperature difference is provided to the front side and the back side.

In addition, it is preferable that the raw material is preheated before the vertical stretching. A preheating temperature is preferably Tg of a cyclic olefin copolymerization resin−50° C. to Tg+30° C., is more preferably Tg−40° C. to Tg+15° C., and is even more preferably Tg−30° C. to Tg. Such preheating may be performed by being in contact with a heating roll, may be performed by using a radiation heat source (an IR heater, a halogen heater, and the like), or may be performed by blowing hot air.

It is preferable that the vertical stretching is performed at a temperature of Tg−10° C. to Tg+50° C., is preferably performed at a temperature of Tg to Tg+40° C., and is more preferably performed at a temperature of Tg to Tg+30° C. A stretching ratio is preferably 1.1 times to 5.5 times, and is more preferably 1.3 times to 3 times. Furthermore, here, the stretching ratio is a value obtained by the following expression.

Stretching Ratio=(Length after Stretching−Length before Stretching)/(Length before Stretching)

It is preferable that cooling is performed after the vertical stretching, and a cooling temperature is preferably Tg−50° C. to Tg, is more preferably Tg−45° C. to Tg−5° C., and is even more preferably Tg−40° C. to Tg−10° C. Such cooling may be performed by being in contact with a cooling roll, or may be performed by blowing cold air.

It is preferable that the horizontal stretching is performed by using a tenter. That is, the horizontal stretching is able to be performed by widening a clip in a width direction while transporting a polyester film to a heat treatment zone in a state where both ends of the polyester film are gripped by the clips.

A stretching temperature is preferably Tg−10° C. to Tg+50° C., is more preferably Tg to Tg+40° C., and is even more preferably Tg to Tg+30° C. A stretching ratio is preferably 1.1 times to 5.5 times, and is more preferably 1.3 times to 3 times.

In a stretching step, it is preferable that the film is subjected to a heat treatment after a stretching treatment.

The heat treatment is performed with respect to the film at a temperature of approximately Tg+10° C. to Tg+50° C. (more preferably, Tg+15° C. to Tg+30° C.) for 1 second to 60 seconds (more preferably, 2 seconds to 30 seconds). It is preferable that thermal fixing is performed in a state where the horizontal stretching is continuously performed and the film is gripped by chucks in the tenter, and at this time, a gap between the chucks may be identical to the width at the time of ending the horizontal stretching, may be wider than the width, or may be thinner than the width. By performing the heat treatment, it is possible to adjust Re and Rth to be in the range of the present invention.

(7) Winding

It is preferable that both ends of the sheet obtained as described above are trimmed and wound. The trimmed portion may be reused as a raw material for the same type of film or a raw material for various types of films after being subjected to a pulverization treatment, or as necessary, a granulation treatment or a depolymerization or repolymerization treatment. Any type of cutter such as a rotary cutter, a shearing blade, and a knife may be used as a trimming cutter. Either carbon steel or stainless steel may be used as the material of the trimming cutter. In general, in a case where a cemented carbide blade and a ceramic blade are used, it is preferable since the life cycle of the cutter is long, and the occurrence of chips is suppressed.

In addition, it is also preferable that a laminated film is attached onto at least one surface before performing winding from a viewpoint of preventing damage. A winding tension is preferably 1 kg/m width to 50 kg/m width, is more preferably 2 kg/m width to 40 kg/m width, and is even more preferably 3 kg/m width to 20 kg/m width. In a case where the winding tension is greater than or equal to 1 kg/m width, it is preferable since the film is able to be easily evenly wound. In addition, in a case where the winding tension is less than or equal to 50 kg/m width, the film is not subjected to hard winding, a winding appearance is excellent, and a convex portion of the film does not cause waving of the film by extending due to a creep phenomenon or residual birefringence due to the stretching of the film is not generated. The winding tension is sensed by tension control in the middle of a line, and it is preferable that the winding is performed while performing the control such that the winding tension becomes constant. The length of the film may be slightly different according to the position of the film formation line, and according to thermal expansion in a case where there is a difference in the temperature of the film, and thus, it is necessary that a tension greater than or equal to a defined value is not applied to the film in the middle of the line by adjusting a drawing ratio between the nip rolls.

By controlling the winding tension using the tension control, it is possible to perform the winding at a constant tension, and it is more preferable that a suitable winding tension is set by performing tapering according to the winding diameter. In general, the tension is slightly reduced as the winding diameter becomes larger, and according to a case, it may be preferable that the tension increases as the winding diameter becomes larger. Such a winding method is able to be similarly applied to the following solution film formation method.

(Solution Film Formation)

(1) Film Formation

When the optical film is formed by a solution film formation method, first, the cyclic olefin-based resin and the elastomer are dissolved in a solvent. When the cyclic olefin-based resin and the elastomer are dissolved in the solvent, the total concentration of the cyclic olefin-based resin and the elastomer is preferably 3 mass % to 50 mass %, is more preferably 5 mass % to 40 mass %, and is even more preferably 10 mass % to 35 mass %. Viscosity of a solution to be obtained at room temperature is generally 1 (mPa·s) to 1,000,000 (mPa·s), is preferably 10 (mPa·s) to 100,000 (mPa·s), is more preferably 100 (mPa·s) to 50,000 (mPa·s), and is particularly preferably 1,000 (mPa·s) to 40,000 (mPa·s).

Examples of the solvent to be used are able to include an aromatic solvent such as benzene, toluene, and xylene, a cellosolve-based solvent such as methyl cellosolve, ethyl cellosolve, and 1-methoxy-2-propanol, a ketone-based solvent such as diacetone alcohol, acetone, cyclohexanone, methyl ethyl ketone, 4-methyl-2-pentanone, ethyl cyclohexanone, and 1,2-dimethyl cyclohexane, an ester-based solvent such as methyl lactate and ethyl lactate, a halogen-containing solvent such as 2,2,3,3-tetrafluoro-1-propanol, methylene chloride, and chloroform, tetrahydrofuran, an ether-based solvent such as dioxane, and an alcohol-based solvent such as 1-pentanol and 1-butanol.

In addition, it is preferable that a solvent is used in which an SP value (parameters of the degree of solubility) is generally in a range of 10 (MPa^{1/2}) to 30 (MPa^{1/2}). The solvent described above is able to be independently used or two or more types thereof are able to be used in combination. In a case where two or more types of solvents are used in combination, it is preferable that the SP value of a mixture is in the range described above. At this time, the SP value of the mixture is able to be obtained from a mass ratio thereof, and for example, in a case where two types of mixtures are used, mass fractions of the respective solvents are set to W1 and W2, and the SP values are set to SP1 and SP2, the SP value of the mixed solvent is able to be obtained as a value calculated by the following expression.

SP Value=W1·SP1+W2·SP2

Further, in order to improve surface smoothness of the optical film, a leveling agent may be added. Any leveling agent is able to be used insofar as the leveling agent is a general leveling agent, and for example, a fluorine-based nonionic surfactant, a special acrylic resin-based leveling agent, a silicone-based leveling agent, and the like are able to be used.

Examples of a method of manufacturing the optical film by the solvent casting method generally include a method in which the solution is applied onto a substrate such as a metal drum, a steel belt, a polyester film of polyethylene terephthalate (PET), polyethylene naphthalate (PEN), or the like, and a polytetrafluoroethylene belt using a die or a coater, and then the solvent was dried and removed, and thus, a film is peeled off from the substrate.

In addition, the optical film is able to be manufactured by applying a resin solution onto a substrate using means such as a spray, a brush, roll spin coat, and dipping, and then by drying and removing the solvent, and by peeling off a film from the substrate. Furthermore, thickness, surface smoothness, and the like may be controlled by repeating the coating.

In addition, in a case where the polyester film is used as the substrate, a film which is subjected to a surface treatment may be used. Examples of a method of the surface treatment include a hydrophilization treatment method which is generally performed, for example, a method of laminating an acrylic resin or a sulfonic acid salt group-containing resin by coating or laminating, a method of improving hydrophilicity of a film surface by a corona discharge treatment or the like, and the like.

(2) Drying

A drying (solvent removing) step of the solvent casting method described above is not particularly limited, and is able to be performed by a method which is generally used, for example, a method of allowing the solvent to pass through a drying furnace by a plurality of rollers, but in a case where air bubbles occur due to evaporation of the solvent in the drying step, properties of the film considerably deteriorate, and thus, in order to avoid such deterioration, it is preferable that the drying step is divided into a plurality of steps including two or more steps, and the temperature or the air volume in each of the steps is controlled.

In addition, the amount of residual solvent in the optical film is generally less than or equal to 10 mass %. In a case where the amount of residual solvent is set to be small as described above, it is preferable since sticking mark trouble is able to be further reduced.

(3) Stretching

It is preferable that the optical film obtained as described above is stretched in at least a monoaxial direction of the vertical direction (MD) or the horizontal direction (TD), and it is more preferable that the optical film is biaxially stretched in the vertical direction (MD) and the horizontal direction (TI)). A stretching method at the time of performing the melting film formation is able to be adopted as a stretching method.

(Surface Protection Film)

The optical film of the present invention is able to be used as a surface protection film. For example, the optical film is able to be used as a protection film for a polarizing plate, and the like. The optical film of the present invention is suitably used as a surface film for a display device.

(Polarizing Plate)

The optical film of the present invention may be set as a polarizing plate by being combined with a polarizer. The polarizing plate includes a polarizer, and protection films disposed on both sides of the polarizer, in which at least one of the protection films is the optical film of the present invention. In the optical film, it is preferable that a contact angle of the surface of a transparent support on a side opposite to a side onto which a light scattering layer or an antireflection layer is disposed, that is, the surface on a side onto which the polarizer is bonded with respect to water is in a range of 10 degrees to 50 degrees. For example, it is possible to arrange an adhesive layer on the uppermost surface of a display by disposing the adhesive layer on one surface of the optical film of the present invention.

(Display Device)

The optical film of the present invention or the polarizing plate including the optical film of the present invention described above is able to be used in various display devices such as a liquid crystal display device (LCD), a plasma display panel (PDP), an electroluminescence display (ELD), and a cathode tube display device (CRT). It is preferable that the optical film of the present invention or the polarizing plate is arranged on a visible side of a display screen of an image display device.

<Liquid Crystal Display Device>

It is particularly preferable that the optical film of the present invention or the polarizing plate is used in the outermost layer of the display such as a liquid crystal display device. The liquid crystal display device includes a liquid crystal cell, and two polarizing plates arranged on both sides of the liquid crystal cell, in which the liquid crystal cell supports a liquid crystal between two electrode substrates. Further, one optically anisotropic layer is arranged between the liquid crystal cell and one polarizing plate, or two optically anisotropic layers are arranged between the liquid crystal cell and both of the polarizing plates.

It is preferable that the liquid crystal cell is in a TN mode, a VA mode, an OCB mode, an IPS mode, or an ECB mode.

In the liquid crystal cell of the TN mode, rod-like liquid crystal molecules are substantially subjected to horizontal orientation at the time of not applying a voltage, and are further subjected to twist orientation by 60° to 1200.

The liquid crystal cell of the TN mode is most frequently used as a color TFT liquid crystal display device, and is disclosed in a plurality of literatures.

In the liquid crystal cell of the VA mode, the rod-like liquid crystal molecules are substantially subjected to vertical orientation at the time of not applying a voltage.

The liquid crystal cell of the VA mode includes (1) a liquid crystal cell (disclosed in JP1990-176625A (JP-H02-176625A)) of a VA mode in the narrow sense in which rod-like liquid crystal molecules are substantially subjected to vertical orientation at the time of not applying a voltage and are substantially subjected to horizontal orientation at the time of applying a voltage, (2) a liquid crystal cell (of an MVA mode) (disclosed in SID97, Digest of Tech. Papers (Proceedings) 28 (1997) 845) in which a VA mode is subjected to multidomain in order to enlarge a view angle, (3) a liquid crystal cell of a mode (an n-ASM mode) (disclosed in Proceedings 58 to 59 of Japan Liquid Crystal Debate (1998)) in which rod-like liquid crystal molecules are substantially subjected to vertical orientation at the time of not applying a voltage and are subjected to twist multidomain orientation at the time of applying a voltage, and (4) a liquid crystal cell of a SURVAIVAL mode (published in LCD International 98).

The liquid crystal cell of the OCB mode is a liquid crystal cell of a bend orientation mode in which the rod-like liquid crystal molecules are substantially subjected to orientation in opposite directions (symmetrically) on the upper portion and the lower portion of the liquid crystal cell, and is disclosed in each specification of U.S. Pat. No. 4,583,825A and U.S. Pat. No. 5,410,422A. The rod-like liquid crystal molecules are symmetrically subjected to orientation on the upper portion and the lower portion of the liquid crystal cell, and thus, the liquid crystal cell of the bend orientation mode has a self-optical compensation function. For this reason, the liquid crystal mode is referred to as an Optically Compensatory Bend (OCB) liquid crystal mode. The liquid crystal display device of the bend orientation mode has advantages such as a high response speed.

The liquid crystal cell of the IPS mode is in a mode where switching is performed by applying a horizontal electric field to a nematic liquid crystal, the details thereof are disclosed in pp. 577 to 580 and pp. 707 to 710 of Proc. IDRC (Asia Display '95).

In the liquid crystal cell of the ECB mode, the rod-like liquid crystal molecules are substantially subjected to horizontal orientation at the time of not applying a voltage. The ECB mode is one of liquid crystal display modes, which has the simplest structure, and for example, the details thereof are disclosed in JP1993-203946A (JP-H05-203946A).

<Plasma Display Panel (PDP)>

In general, a plasma display panel (PDP) is configured of gas, a glass substrate, an electrode, an electrode lead material, a thick film printing material, and a fluorescent body. The glass substrate includes two substrates of a front glass substrate and a back glass substrate. An electrode and an insulating layer are formed on the two glass substrates. A fluorescent layer is further formed on the back glass substrate. The two glass substrates are combined, and a space between the glass substrates is sealed with gas.

A plasma display panel which is already commercially available is able to be used as the plasma display panel (PDP). The plasma display panel is disclosed in each publication of JP1993-205643A (JP-H05-205643A) and JP1997-306366A (JP-H09-306366A).

A front plate may be arranged on the front side of the plasma display panel. It is preferable that the front plate has sufficient strength for protecting the plasma display panel. The front plate is able to be used by providing a gap between the front plate and the plasma display panel, and is able to be used by being bonded to a plasma display main body.

In an image display device such as a plasma display panel, the optical filter is able to be directly bonded to a display surface. In addition, in a case where the front plate is disposed in front of the display, the optical filter is able to be bonded to the front side (the outer side) or the back side (the display side) of the front plate.

(Organic EL Element)

The optical film of the present invention is able to be used as a substrate (a substrate film) or a protection film of an organic EL element or the like. In a case where the film of the present invention is used in the organic EL element or the like, the contents disclosed in each publication of JP1999-335661A (JP-H11-335661A), JP1999-335368A (JP-H11-335368A), JP2001-192651A, JP2001-192652A, JP2001-192653A, JP2001-335776A, JP2001-247859A, JP2001-181616A, JP2001-181617A, JP2002-181816A, JP2002-181617A, JP2002-056976A, and the like are able to be applied. In addition, it is preferable that the contents disclosed in each publication of JP2001-148291A, JP2001-221916A, and JP2001-231443A are used in combination.

(Transparent Conductive Film)

The optical film of the present invention is able to be used in a transparent conductive film. The transparent conductive film includes a conductive layer (a transparent conductive layer), and an optical film as a transparent resin film. The conductive layer may be formed in the shape of a layer, and it is preferable that the conductive layer is formed to include an intermittent portion. The intermittent portion indicates a portion on which the conductive layer is not disposed, and it is preferable that the outer circumference of the intermittent portion is surrounded by the conductive layer. In the present invention, the conductive layer which is formed to include the intermittent portion indicates a conductive layer which is formed in the shape of a pattern or a mesh. Conductive layers, for example, disclosed in JP2013-1009A, JP2012-216550A, JP2012-151095A, JP2012-25158A, JP2011-253546A, JP2011-197754A, JP2011-34806A, JP2010-198799A, JP2009-277466A, JP2012-216550A, JP2012-151095A, WO2010/140275A, and WO2010/114056A are able to be exemplified as the conductive layer.

It is more preferable that the conductive layer used in the present invention contains silver and a hydrophilic resin. Examples of a water soluble resin include gelatin, polyvinyl alcohol (PVA), polyvinyl pyrrolidone (PVP), polysaccharides such as starch, cellulose and a derivative thereof, polyethylene oxide, polyvinyl amine, chitosan, polylysine, a polyacrylic acid, a polyalginic acid, a polyhyaluronic acid, carboxy cellulose, and the like. The water soluble resin has properties such as neutrality, anionic properties, and cationic properties according to ionic properties of a functional group. Among them, the gelatin is particularly preferable.

It is particularly preferable that silver halide photographic sensitive material is used in the conductive layer used in the present invention. In a case where a silver halide photographic sensitive material is used, the following three aspects are included in a manufacturing method of a conductive layer according to the type of photosensitive material and development treatment.

(1) An aspect in which a photosensitive silver halide black and white sensitive material which does not include physical development nuclei is subjected to chemical development or thermal development, and thus, a metal silver portion is formed on the photosensitive material.

(2) An aspect in which a photosensitive silver halide black and white sensitive material which includes physical development nuclei in a silver halide emulsion layer is subjected to solution physical development, and thus, a metal silver portion is formed on the photosensitive material.

(3) An aspect in which a photosensitive silver halide black and white sensitive material which does not include physical development nuclei and an image receiving sheet including a non-photosensitive layer which includes physical development nuclei are subjected to superposition and diffusion transfer development, and thus, a metal silver portion is formed on the non-photosensitive image receiving sheet.

The aspect of (1) is an integrated black and white development type, and in the aspect, a transmissive conductive film such as a light transmissive conductive film is formed on the photosensitive material. Development silver to be obtained is chemical development silver or thermal development silver, in a case where the development silver is a filament having a high specific surface area, activity is high during the subsequent plating or physical development.

In the aspect of (2), silver halide particles in the vicinity of the physical development nuclei are dissolved and are settled on the development nuclei in an exposed portion, and thus, the transmissive conductive film such as a light transmissive conductive film is formed on the photosensitive material. The aspect of (2) is also an integrated black and white developing type. A developing action is eduction onto the physical development nuclei, and thus, the activity is high, but the development silver is in the shape of a sphere having a small specific surface.

In the aspect of (3), the silver halide particles are dissolved and diffused and are settled on the development nuclei on the image receiving sheet in an unexposed portion, and thus, the transmissive conductive film such as a light transmissive conductive film is formed on the image receiving sheet. The aspect of (3) is a so-called separate type, and is an aspect in which the image receiving sheet is used by being peeled off from the photosensitive material.

In all aspects, either a negative development treatment or a reversal development treatment is able to be selected, and in a case where the diffusion transfer development is used, an automatic positive photosensitive material is used as the photosensitive material, and thus, it is possible to perform a negative development treatment.

Here, the chemical development, the thermal development, the solution physical development, and the diffusion transfer development indicates terms which are usually used in the art, and are explained in a general textbook of photo chemical, for example, “Photo Chemical” written by KIKUCHI Shinichi (published by KYORITSU SHUPPAN CO., LTD., 1955), and “The Theory of Photographic Processes, 4th ed.” edited by C. E. K. Mees (published by Macmillan Publishers, 1977). The present invention relates to a liquid treatment, but is able to refer to a technology to which a thermal development method is applied as other developing methods. For example, technologies disclosed in each publication of JP2004-184693A, JP2004-334077A, and JP2005-010752A, and each specification of JP2004-244080 and JP2004-085655 are able to be applied.

In the present invention, a silver salt emulsion layer which becomes the conductive layer may contain additives such as a solvent or a dye in addition to a silver salt and a binder.

Examples of the silver salt include an inorganic silver salt such as silver halide and an organic silver salt such as silver acetate. In the present invention, it is preferable that the silver halide having excellent properties as an optical sensor is used.

A solvent used for forming the silver salt emulsion layer is not particularly limited, and examples of the solvent are able to include water, an organic solvent (for example, alcohols such as methanol, ketones such as acetone, amides such as formamide, sulfoxides such as dimethyl sulfoxide, esters such as ethyl acetate, ethers, and the like), an ionic liquid, and a mixed solvent thereof.

A protection layer may be disposed on the silver salt emulsion layer. In the present invention, the protection layer indicates a layer formed of a binder such as gelatin or a high molecular polymer, and is formed on the silver salt emulsion layer having photosensitivity in order to exhibit effects such as scratch prevention or enhancement in dynamic properties. It is preferable that the thickness is less than or equal to 0.5 μm. A coating method and a formation method of the protection layer are not particularly limited, and a known coating method and a known formation method are able to be suitably selected. For example, the protection layer is able to refer to a protection layer disclosed in JP2008-250233A and the like.

Further, in the present invention, other functional layers such as an undercoat layer or an antistatic layer may be disposed. An undercoat layer disclosed in paragraphs “0021” to “0023” of JP2008-250233A is able to be applied as the undercoat layer. In addition, an antistatic layer disclosed in paragraphs “0012” and “0014” to “0020” of JP2008-250233A is able to be applied as the antistatic layer.

(Touch Panel)

The transparent conductive film described above is suitable for a touch panel, and for example, a touch panel is able to be prepared according to a method disclosed in paragraphs “0073” to “0075” of JP2009-176608A.

The touch panel of the present invention is incorporated in a display device or the like such as a liquid crystal display, a plasma display, an organic EL display, a CRT display, and an electronic paper, and thus, is able to be used as an input device. By using the touch panel of the present invention, the occurrence of interference unevenness is suppressed, and a touch panel having an excellent tint is able to be obtained.

The configuration of the touch panel includes a resistance film type touch panel, an electrostatic capacitance type touch panel, and the like, in which an input device of the electrostatic capacitance type touch panel has advantages in which the electrostatic capacitance type touch panel may be simply obtained by forming a transmissive conductive film on one substrate, and thus, the electrostatic capacitance type touch panel is preferable. In the input device of the electrostatic capacitance type touch panel, for example, a transparent electrode layer in which electrode patterns extend in directions intersecting with each other, a change in electrostatic capacitance between electrodes is sensed at the time of being touched by a finger or the like, and an input position is detected is able to be preferably used as the transparent electrode layer. The configuration of such a touch panel is able to refer to a configuration disclosed, for example, in JP2010-86684A, JP2010-152809A, JP2010-257492A, and the like.

Configuration disclosed in “The Latest Touch Panel Technology” supervised by MITANI Yuuji (published by Techno Times Co., Ltd. on Jul. 6, 2009), “Technology and Development of Touch Panel” published by CMC Publishing Co., Ltd. (2004,12), FPD International 2009 Forum T-11 Presentation Textbook, Cypress Semiconductor Corporation Application Note AN 2292, and the like are able to be applied as the configuration of an image display device including the touch panel as a constituent.

In addition, the configuration of the liquid crystal display in which the touch panel is able to be incorporated is able to refer to configurations disclosed in JP2002-48913A and the like.

### EXAMPLES

Hereinafter, the present invention will be described in more detail with reference to examples and comparative examples described above. Furthermore, materials, use amounts, ratios, treatment contents, treatment sequences, and the like described in the following examples are able to be suitably changed unless the change deviates from the gist of the present invention. However, the scope of the present invention will not be restrictively interpreted by the following specific examples.

### Example 1

### Preparation of Optical Film

80 mass % of Topas 5013 (manufactured by Polyplastics Co., Ltd.) as a cyclic olefin-based resin and 20 mass % of Kraton RP6935 (a styrene-ethylene-butylene-styrene block copolymer (SEBS) (manufactured by Kraton Performance Polymers Inc.)) as an elastomer were melted at 260° C., and were kneaded and extruded by using a biaxial kneading extruder. At this time, a screen filter, a gear pump, and a leaf type disk filter were sequentially arranged between an extruder and a die and were connected to each other through a melt pipe, and thus, extrusion was performed from the die having a width of 450 mm and a lip gap of 1 mm.

Next, the extruded melt was cast onto three casting rolls of which the glass-transition temperature was set to Tg, (Tg+5)° C., and (Tg−10)° C., a touch roll of which the temperature was adjusted to be Tg−5° C., disclosed in Example 1 of JP1999-235747A (JP-H11-235747A), was brought into contact with the casting roll on the most upstream side, and thus, an unstretched film was formed.

The solidified melt was peeled off from the casting drum, both ends thereof (5% of each total width) were trimmed immediately before being wound, and then the both ends were subjected to thickness processing (knurling) to have a width of 10 mm and a height of 50 pun, and thus, an unstretched film having a width of 2.0 m, a length of 500 m, and a thickness of 160 μm at 30 m/minute was obtained.

The obtained unstretched film passed through two pairs of nip rolls having different rotation speeds at a stretching temperature and a ratio shown in Table 1, was stretched in a vertical direction, and was horizontally stretched by a tenter, and thus, a cyclic olefin-based resin film of Example 1 was obtained.

### Examples 2 to 6

Cyclic olefin-based resin films of Examples 2 to 6 were obtained by the same method as that in Example 1 except that the type and the mixed amount of elastomer and the thickness of the unstretched film were changed according to Table 1, and stretching conditions were set as shown in Table 1.

### Example 7

A cyclic olefin-based resin film of Example 7 was obtained by the same method as that in Example 1 except that Topas 6017 (manufactured by Polyplastics Co., Ltd.) was used as the cyclic olefin-based resin, and the thickness of the unstretched film was changed according to Table 1.

### Examples 8 to 11

Cyclic olefin-based resin films of Examples 8 to 11 were obtained by the same method as that in Example 7 except that the type and the mixed amount of elastomer and the thickness of the unstretched film were changed according to Table 1. Furthermore, Kraton MD1537 manufactured by Kraton Performance Polymers Inc. was used.

### Examples 12 to 16

Cyclic olefin-based resin films of Examples 12 to 16 were obtained by the same method as that in Example 1 except that the type and the mixed amount of elastomer and the thickness of the unstretched film were changed according to Table 1, and the stretching conditions were set as shown in Table 1. Furthermore, Septon 2104 manufactured by KURARAY CO., LID was used.

### Example 17

A cyclic olefin-based resin film of Example 17 was obtained by the same method as that in Example 1 except that ARTON D4540 (manufactured by JSR Corporation) was used as the as the cyclic olefin-based resin, and the mixed amount of elastomer was set as shown in Table 1.

### Comparative Example 1

A cyclic olefin-based resin film of Comparative Example 1 was obtained by using Topas 5013 as the cyclic olefin-based resin. Manufacturing steps before a step of obtaining the unstretched film were identical to those in Example 1. Furthermore, in Comparative Example 1, the elastomer was not mixed, and the film was not stretched.

### Comparative Example 2

A cyclic olefin-based resin film of Comparative Example 2 was obtained by the same method as that in Comparative Example 1 except that 20 mass % of Kraton RP6935 (a styrene-ethylene-butylene-styrene block copolymer (SEBS)) was mixed as the elastomer.

### Comparative Example 3

A cyclic olefin-based resin film of Comparative Example 3 was obtained by the same method as that in Comparative Example 1 except that a stretching step was provided in the conditions of Table 1.

### Comparative Example 4

A cyclic olefin-based resin film of Comparative Example 4 was obtained by the same method as that in Example 1 except that the stretching step was provided in the conditions of Table 1.

### Comparative Example 5

A cyclic olefin-based resin film of Comparative Example 5 was obtained by using the conditions as those in Comparative Example 1 except that 80 mass % of Topas 6017 was used as the cyclic olefin-based resin, and 20 mass % of Kraton MD1537 (a styrene-ethylene-butylene-styrene block copolymer (SEBS) (manufactured by Kraton Performance Polymers Inc.)) was used as the elastomer.

### Comparative Example 6

A cyclic olefin-based resin film of Comparative Example 6 was obtained by the same method as that in Comparative Example 1 except that Topas 6017 was used as the cyclic olefin-based resin, and the stretching step was provided according to the conditions of Table 1. Furthermore, in Comparative Example 6, the elastomer was not mixed.

### Comparative Example 7

A cyclic olefin-based resin film of Comparative Example 7 was obtained by the same method as that in Comparative Example 1 except that ARTON D4540 was used as the cyclic olefin-based resin. Furthermore, in Comparative Example 7, the elastomer was not mixed, and the film was not stretched.

(Evaluation)

(Impact Strength)

A film impact tester manufactured by Toyo Seiki Seisaku-sho Ltd. was used under an environment of a temperature of 23° C. and humidity of 65%, and impact strength of the cyclic olefin-based resin film was measured.

(Inside Haze)

A haze value of each film was measured by a hazemeter (a turbidity meter HZ-1 type (manufactured by Suga Test Instruments Co., Ltd.)). In order to cancel an influence on the haze according to the shape of a surface, phosphoric acid tritolyl was put into a cell, and measurement was performed in a state where a sample was dipped into the cell.

(Rainbow-Like Unevenness)

A transparent conductive film prepared in the present invention was incorporated in a touch panel, a tint change at the time of obliquely observing the film in a dark room and a bright room was evaluated in three steps. Furthermore, rainbow-like unevenness of greater than or equal to C Evaluation was determined as a practical level.

A: The tint change did not occur in both of the dark room and the bright room.

B: The tint change slightly occurred in the dark room, but did not occur in the bright room.

C: The tint change slightly occurred in the bright room.

D: The tint change occurred, and quality of a display device deteriorated.

(Planarity)

A surface state of the film was visually observed, and was evaluated as described below. Furthermore, planarity of greater than or equal to B Evaluation was determined as a practical level.

A: Conspicuous foreign substances were not able to be observed.

B: The foreign substances were slightly observed.

C: A plurality of foreign substances were able to be observed on the entire film.

(Slipperiness)

Two films were superposed, the feeling at the time of moving the films by a finger was evaluated as described below. Furthermore, slipperiness of greater than or equal to B Evaluation was determined as a practical level.

A: Slippery.

B: Slippery even though slight resistance exists.

C: Not slippery.

TABLE 1

| | | | Stretching Conditions | | | | | | |
|---|---|---|---|---|---|---|---|---|---|
| | | | Film | | | | | Elastomer | |
| | Cyclic Olefin-Based | | Thickness of | | Vertical | Horizontal | | | Mixed |
| | Resin | | Unstretched | | Stretching | Stretching | Rth40 | | Amount |
| | Type | Tg (° C.) | Film (μm) | Temperature | Ratio | Ratio | (nm) | Type | (mass %) |
| Example 1 | Topas 5013 | 130 | 160 | Tg + 8° C. | 2 | 2 | 39 | Kraton | 20 |
| | | | | | | | | RP6935 | |
| | | | | | | | | (SEBS) | |
| Example 2 | Topas 5013 | 130 | 160 | Tg + 8° C. | 2 | 2 | 39 | Kraton | 40 |
| | | | | | | | | RP6935 | |
| | | | | | | | | (SEBS) | |
| Example 3 | Topas 5013 | 130 | 160 | Tg + 8° C. | 2 | 2 | 39 | Kraton | 5 |
| | | | | | | | | RP6936 | |
| | | | | | | | | (SBBS) | |
| Example 4 | Topas 5013 | 130 | 160 | Tg + 8° C. | 2 | 2 | 39 | Kraton | 10 |
| | | | | | | | | RP6937 | |
| | | | | | | | | (SEBS) | |
| Example 5 | Topas 5013 | 130 | 250 | Tg + 8° C. | 2.5 | 2.5 | 90 | Kraton | 20 |
| | | | | | | | | RP6938 | |
| | | | | | | | | (SEBS) | |
| Example 6 | Topas 5013 | 130 | 160 | Tg + 15° C. | 2 | 2 | 8 | Kraton | 20 |
| | | | | | | | | RP6939 | |
| | | | | | | | | (SEBS) | |
| Comparative | Topas 5013 | 130 | 40 | — | — | — | 5 | — | — |
| Example 1 | | | | | | | | | |
| Comparative | Topas 5013 | 130 | 40 | — | — | — | 5 | Kraton | 20 |
| Example 2 | | | | | | | | RP6935 | |
| | | | | | | | | (SEBS) | |
| Comparative | Topas 5013 | 130 | 160 | Tg + 8° C. | 2 | 2 | 38 | — | — |
| Example 3 | | | | | | | | | |
| Comparative | Topas 5013 | 130 | 250 | Tg + 3° C. | 2.5 | 2.5 | 120 | Kraton | 20 |
| Example 4 | | | | | | | | RP6935 | |
| | | | | | | | | (SEBS) | |
| Example 7 | Topas 6017 | 173 | 160 | Tg + 8° C. | 2 | 2 | 60 | Kraton | 20 |
| | | | | | | | | RP6935 | |
| | | | | | | | | (SEBS) | |
| Example 8 | Topas 6017 | 173 | 160 | Tg + 8° C. | 2 | 2 | 60 | Kraton | 20 |
| | | | | | | | | MD1537 | |
| | | | | | | | | (SEBS) | |
| Example 9 | Topas 6017 | 173 | 160 | Tg + 8° C. | 2 | 2 | 83 | Kraton | 5 |
| | | | | | | | | MD1537 | |
| | | | | | | | | (SEBS) | |
| Example 10 | Topas 6017 | 173 | 240 | Tg + 8° C. | 2 | 2 | 60 | Kraton | 20 |
| | | | | | | | | MD1537 | |
| | | | | | | | | (SEBS) | |
| Example 11 | Topas 6017 | 173 | 96 | Tg + 8° C. | 2 | 2 | 60 | Kraton | 20 |
| | | | | | | | | MD1537 | |
| | | | | | | | | (SEBS) | |
| Comparative | Topas 6017 | 173 | 40 | — | — | — | 5 | Kraton | 20 |
| Example 5 | | | | | | | | MD1537 | |
| | | | | | | | | (SEBS) | |
| Comparative | Topas 6017 | 173 | 160 | Tg + 8° C. | 2 | 2 | 93 | — | — |
| Example 6 | | | | | | | | | |
| Example 12 | Topas 5013 | 130 | 160 | Tg + 8° C. | 2 | 2 | 40 | Kraton | 20 |
| | | | | | | | | D1101 (SBS) | |
| Example 13 | Topas 5013 | 130 | 270 | Tg + 8° C. | 1.5 | 1.5 | 32 | Kraton | 20 |
| | | | | | | | | RP6935 | |
| | | | | | | | | (SEBS) | |
| Example 14 | Topas 5013 | 130 | 180 | Tg + 8° C. | 1.5 | 1.5 | 32 | Kraton | 20 |
| | | | | | | | | RP6935 | |
| | | | | | | | | (SEBS) | |
| Example 15 | Topas 5013 | 130 | 160 | Tg + 8° C. | 2 | 2 | 40 | Septon 2104 | 20 |
| | | | | | | | | (SEPS) | |
| Example 16 | Topas 5013 | 130 | 160 | Tg + 8° C. | 2 | 2 | 40 | Kraton | 20 |
| | | | | | | | | G1651 | |
| | | | | | | | | (SEBS) | |
| Example 17 | ARTON | 128 | 160 | Tg + 8° C. | 2 | 2 | 50 | Kraton | 10 |
| | D4540 | | | | | | | RP6935 | |
| | | | | | | | | (SEBS) | |
| Comparative | ARTON | 128 | 40 | — | — | — | 5 | — | — |
| Example 7 | D4540 | | | | | | | | |

| | Difference in | | | | | | |
|---|---|---|---|---|---|---|---|
| | Refractive Indices | | | | | | |
| | between Cyclic | Film | Impact | Inside | | | |
| | Polyolefin and | Thickness | Strength | Haze | Rainbow-Like | | |
| | Elastomer (Δn) | (μm) | (kgf · cm) | (%) | Unevenness | Planarity | Slipperiness |
| Example 1 | 0.002 | 40 | 4 | 0.5 | A | A | A |
| Example 2 | 0.002 | 40 | 12 | 1.2 | A | A | A |
| Example 3 | 0.002 | 40 | 1 | 0.1 | A | B | B |
| Example 4 | 0.002 | 40 | 2 | 0.2 | A | A | A |
| Example 5 | 0.002 | 40 | 7 | 0.5 | C | A | A |
| Example 6 | 0.002 | 40 | 1.5 | 0.5 | A | A | A |
| Comparative | — | 40 | 0.1 | 0.1 | A | C | C |
| Example 1 | | | | | | | |
| Comparative | 0.002 | 40 | 0.6 | 0.5 | A | A | A |
| Example 2 | | | | | | | |
| Comparative | — | 40 | 0.8 | 0.1 | A | C | C |
| Example 3 | | | | | | | |
| Comparative | 0.002 | 40 | 8 | 0.5 | D | A | A |
| Example 4 | | | | | | | |
| Example 7 | 0.001 | 40 | 6 | 0.7 | B | A | A |
| Example 8 | 0.002 | 40 | 6.5 | 0.2 | B | A | A |
| Example 9 | 0.002 | 40 | 1.6 | 0.1 | C | B | B |
| Example 10 | 0.002 | 60 | 7 | 0.5 | C | A | A |
| Example 11 | 0.002 | 24 | 3.7 | 0.1 | A | A | A |
| Comparative | 0.002 | 40 | 0.2 | 0.2 | A | A | A |
| Example 5 | | | | | | | |
| Comparative | — | 40 | 0.7 | 0.1 | C | C | C |
| Example 6 | | | | | | | |
| Example 12 | 0.006 | 40 | 5 | 1 | A | C | A |
| Example 13 | 0.002 | 120 | 4.5 | 2.2 | C | A | A |
| Example 14 | 0.002 | 80 | 4 | 1.8 | B | A | A |
| Example 16 | 0.024 | 40 | 7 | 8.5 | A | A | A |
| Example 17 | 0.019 | 40 | 14 | 3.2 | B | A | A |
| Comparative | — | 40 | 3.5 | 0.1 | A | A | C |
| Example 7 | | | | | | | |

As shown in Table 1, in the cyclic olefin-based resin films obtained in Examples 1 to 17, the impact strength is high, and the occurrence of the rainbow-like unevenness is suppressed. Further, it is found that the cyclic olefin-based resin films obtained in Examples 1 to 17 have excellent slipperiness. That is, it is found that in all of the cyclic olefin-based resin films obtained in Examples 1 to 17, the impact strength is high, the occurrence of the rainbow-like unevenness is suppressed, and the slipperiness is excellent.

In contrast, in Comparative Examples 1 to 3, 5 and 6, sufficient impact strength is not obtained. In addition, in Comparative Examples 1, 3, and 6, it was found that the slipperiness of the film deteriorated, and a problem occurred at the time of winding the film. Further, in Comparative Example 6, it was confirmed that the rainbow-like unevenness slightly occurred.

In Comparative Example 4, the impact strength is high, but the rainbow-like unevenness occurs, and thus, the cyclic olefin-based resin film of Comparative Example 4 is not suitable as the cyclic olefin-based resin film.

In Comparative Example 7, it was found that the slipperiness of the film deteriorated, and a problem occurred at the time of winding the film.

Thus, in the present invention, an optical film in which the impact strength is high, the occurrence of the rainbow-like unevenness is suppressed, and the slipperiness is excellent is able to be obtained not only by simply adding the elastomer, but also by carefully selecting the manufacturing method and the composition of the optical film.

### INDUSTRIAL APPLICABILITY

According to the present invention, it is possible to obtain an optical film in which impact resistance and slipperiness of the film are excellent, and the occurrence of rainbow-like unevenness is suppressed. For this reason, the optical film of the present invention has the properties described above, and thus, is preferably used as a film for a display device or a touch panel. In addition, the optical film of the present invention has excellent slipperiness, and thus, has excellent handling properties in a manufacturing step, high production suitability, and high industrial applicability.

What is claimed is:

1. An optical film, comprising:
a cyclic olefin-based resin; and
an elastomer,
wherein a content ratio of the elastomer is 5 mass % to 40 mass % with respect to the total mass of the optical film, and
retardation Rth in a thickness direction in terms of a thickness of 40 μm is 6 nm to 90 nm.

2. The optical film according to claim 1,
wherein a difference in refractive indices of the cyclic olefin-based resin and the elastomer is less than or equal to 0.02.

3. The optical film according to claim 1,
wherein a thickness of the optical film is 10 μm to 100 μm.

4. The optical film according to claim 1,
wherein the thickness of the optical film is 10 μm to 50 μm.

5. The optical film according to claim 1,
wherein the cyclic olefin-based resin is an addition copolymer including an ethylene unit and a norbornene unit.

6. The optical film according to claim 1,
wherein the elastomer contains an aromatic vinyl-based compound as a copolymerization component.

7. The optical film according to claim 1,
wherein the elastomer is a styrene-ethylene-butylene-styrene block copolymer, a styrene-ethylene-propylene-styrene block copolymer, or a styrene-isobutylene-styrene block copolymer.

8. The optical film according to claim 1,
wherein the optical film is stretched in at least a monoaxial direction.

9. The optical film according to claim 1,
wherein the optical film is biaxially stretched.

10. A transparent conductive film, comprising:
the optical film according to claim 1; and
a transparent conductive layer.

11. A touch panel comprising the transparent conductive film according to claim 10.

12. A surface protection film using the optical film according to claim 1.

13. A display device using the optical film according to claim 1.
